(19) United States
(12) Patent Application Publication
(10) Pub. No.: US 2018/0011238 A1
(43) Pub. Date: Jan. 11, 2018

(54) BACKLIGHT UNIT FOR TRANSFLECTIVE LCD PANEL AND TRANSFLECTIVE LCD

(71) Applicant: WUHAN CHINA STAR OPTOELECTRONICS TECHNOLOGY CO., LTD., Wuhan (CN)

(72) Inventor: Chang XIE, Wuhan (CN)

(21) Appl. No.: 15/393,307

(22) Filed: Dec. 29, 2016

(30) Foreign Application Priority Data
Jul. 5, 2016 (CN) 201610522734.5

(51) Int. Cl. F21V 8/00; G02F 1/1345; G02F 1/1335

(52) U.S. Cl. CPC G02B 6/0055; G02F 1/133555; G02F 1/13454

(57) ABSTRACT

A backlight unit for a transflective liquid crystal display (LCD) panel includes a light bar generating displaying light, a light guide plate (LGP) transmitting the displaying light to the display panel, and a first reflective layer provided on a backlight reflective regions of the LGP to reflect the displaying light corresponding to the backlight reflective regions. A light outputting surface of the LGP comprises backlight transmissive regions and the backlight reflective regions.

### BACKGROUND

### 1. Field of the Disclosure

The present disclosure relates to the field of liquid crystal displays, and more particularly to a backlight unit for a transflective liquid crystal display (LCD) panel and a transflective LCD.

### 2. Description of the Prior Art

Conventional liquid crystal displays (LCDs) are divided into a transmissive LCD, a reflective LCD, and a transflective LCD according to different types of light sources.

A transflective LCD has both advantages of a transmissive LCD and a reflective LCD. Namely, the transflective LCD is capable of displaying bright images in a dark environment, and can be used indoors and outdoors. Thus, the transflective LCDs are widely used in display devices of portable mobile electronic products, such as mobile phones, digital cameras, handheld computers, and General Packet Radio Services (GPRS).

The transflective LCD is regarded as a combination of the transmissive LCD and the reflective LCD. A reflective region and a transmissive region are arranged on an array substrate of the transflective LCD, and the transflective LCD uses a backlight source and a front light source, or an external light source at the same time to display.

In the conventional transflective LCD, light from the backlight source is emitted to the reflective region and the transmissive region, the light directed to the transmissive region is fully utilized, and the light emitted to the reflective region is completely shielded by a reflective layer and light energy is wasted, and therefore the light utilization and light efficiency of the backlight source are reduced.

Therefore, it is necessary to provide a transflective LCD to solve the above issue of the prior art.

### SUMMARY OF THE DISCLOSURE

In order to improve light utilization and light efficiency of the backlight unit. The present disclosure is to provide a backlight unit for a transflective liquid crystal display (LCD) panel and a transflective LCD.

The present disclosure provides the backlight unit for the transflective LCD panel, where the backlight unit for the transflective LCD panel comprises:

a light bar generating displaying light;

a light guide plate (LGP) transmitting the displaying light to the transflective LCD panel; a light outputting surface of the LGP comprises backlight transmissive regions and backlight reflective regions; and,

a first reflective layer provided on the backlight reflective regions of the LGP to reflect the displaying light corresponding to the backlight reflective regions.

In the backlight unit for the transflective LCD panel of the present disclosure, a second reflective layer is arranged on a bottom surface of the LGP, material of the first reflective layer comprises metal, and material of the second reflective layer comprises metal. The metal material comprises aluminum and silver, which improves reflection of the reflective layer.

In the backlight unit for the transflective LCD panel of the present disclosure, the backlight transmissive regions and the backlight reflective regions are alternately arranged on the light outputting surface of the LGP.

In the backlight unit for the transflective LCD panel of the present disclosure, the first reflective layer is a single-sided reflective layer and a reflective surface of the first reflective layer faces the LGP. Thus, only one surface of the first reflective layer facing to the LGP has reflective function, which reduces technology.

The present disclosure further provides a transflective liquid crystal display (LCD), where the transflective LCD comprises: an LCD panel and a backlight unit.

The LCD panel comprises transmissive regions of the LCD panel and reflective regions of the LCD panel.

The transmissive regions of the LCD panel comprise a top substrate, a liquid crystal layer, and a bottom substrate.

The reflective regions of the LCD panel comprise a top substrate, a liquid crystal layer, a bottom substrate, and a reflective layer of the LCD panel arranged between the top substrate and the bottom substrate.

The backlight unit comprises:

a light bar generating displaying light;

a light guide plate (LGP) transmitting the displaying light to the transflective LCD panel; a light outputting surface of the LGP comprises backlight transmissive regions and backlight reflective regions; and,

a first reflective layer provided on the backlight reflective regions of the LGP to reflect the displaying light corresponding to the backlight reflective regions.

In the transflective LCD of the present disclosure, the backlight reflective regions correspond to the reflective regions of the LCD panel, and the backlight transmissive region is corresponded to the transmissive region of the LCD panel. Thus, the displaying light shielded by the reflective layer of the LCD panel is reflected in the LGP via the first reflective layer to continue to transmit until the shielded displaying light emits from the backlight transmissive region, which avoids the display light from wasting.

In the transflective LCD of the present disclosure, height of the liquid crystal layer of the transmissive regions of the LCD panel is greater than height of the liquid crystal layer of the reflective regions of the LCD panel, which allows that the transmissive regions of the LCD panel and the reflective regions of the LCD panel have same electro-optical characteristic, further improving light utilization and light efficiency of the transflective LCD, and image displaying.

In the transflective LCD of the present disclosure, a second reflective layer is arranged on a bottom surface of the LGP, material of the first reflective layer comprises metal, and material of the second reflective layer comprises metal. The metal material comprises aluminum and silver, which improves reflection of the reflective layer.

In the transflective LCD of the present disclosure, the first reflective layer is a single-sided reflective layer and a reflective surface of the first reflective layer faces the LGP. Thus, only one surface of the first reflective layer facing to the LGP has reflective function, which reduces technology.

In the transflective LCD of the present disclosure, the backlight reflective regions and the backlight transmissive regions are alternately arranged on a light outputting surface of the LGP.

In the backlight unit for the transmissive LCD panel of the present disclosure, the first reflective layer is provided on the backlight reflective regions of the light outputting surface of the LGP, and the shielded displaying light is reflected by the first reflective layer and is reflected in the LGP to continue to transmit until the shielded displaying light emits from the backlight transmissive regions of the LGP and is fully utilized. The wasted displaying light gets secondary use, which improves light utilization and light efficiency and reduces power dissipation of the LCD.

### BRIEF DESCRIPTION OF THE DRAWINGS

In order to more clearly illustrate the present disclosure or the technology of the present art, a description is made to the drawings which are needed for carrying out the embodiments. The drawings described hereinafter are only related to some embodiments of the present disclosure. A person skilled in the art, without spending too many endeavors, should be able to obtain other drawings from the disclosed drawings.

FIG. 1 is a structural diagram of a backlight unit for a transflective display panel of the present disclosure.

FIG. 2 is a structural diagram of a transflective liquid crystal display (LCD) of the present disclosure.

### DETAILED DESCRIPTION

Please refer to the drawings, the components having similar structures are denoted by the same numerals, the following description is based on a specific embodiment of the present disclosure, which is not intended to limit other specific embodiment that is not described in the present disclosure.

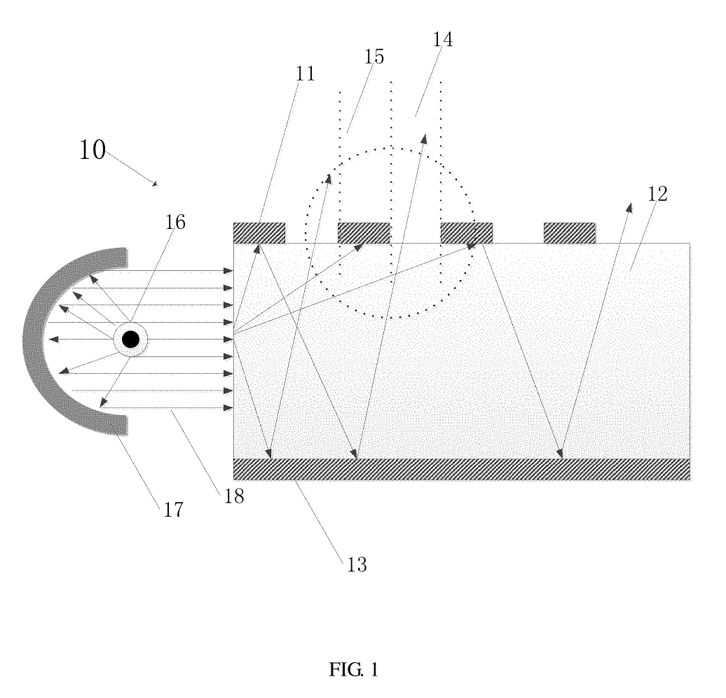

As shown in FIG. 1, FIG. 1 is a structural diagram of a backlight unit 10 for a transflective liquid crystal display (LCD) panel of a preferred embodiment, where the backlight unit 10 comprises a light bar 16, a lampshade 17, a light guide plate (LGP) 12, a first reflective layer 11 and a second reflective layer 13.

The light bar 16 generates displaying light 18. To be specific, the light bar 16 is a light-emitting diode (LED) light bar. A number of the light bar 16 is one or more, which is adjusted according to conditions of different embodiments. The lampshade 17 reflects the displaying light 18 generated by the light bar 16 and the displaying light 18 is parallelly directed to the LGP 12. The lampshade 17 is a curved structure and a concave surface of the curved structure faces the light bar 16, namely a reflective surface of the lampshade 17 faces the light bar 16. To be specific, material of the lampshade comprises metal, such as aluminum and silver. The LGP 12 transmits the displaying light to a display panel. The LGP 12 comprises a light incident surface and a light outputting surface, where the incident surface and the light outputting surface forms a right angle therebetween. The light bar 16 is located between the lampshade 17 and the light incident surface of the LGP 12. The light outputting surface of the LGP 12 comprises backlight transmissive regions 14 and backlight reflective regions 15. The backlight reflective regions 15 and the backlight transmissive regions 14 are alternately arranged on the light outputting surface of the LGP 12. The first reflective layer 11 is provided on the backlight reflective regions 15 of the LGP 12 to reflect the displaying light corresponding to the backlight reflective regions 15. The first reflective layer 11 is a single-sided reflective layer and a reflective surface of the first reflective layer 11 faces the LGP 12, thus, only one surface of the first reflective layer 11 facing the LGP 12 has reflective function. To be specific, materials of the first reflective layer 11 and the second reflective layer 12 comprises metal, such as aluminum and silver. The metal material of the reflective layer has better reflective function.

In the embodiment, the displaying light 18 moves in a manner as disclosed follows: the displaying light 18 generated by the light bar 16 hits the light incident surface of the LGP 12 directly or is reflected by the lampshade 17 to form the parallel light and the parallel light hits the light incident surface of the LGP 12, whereby the displaying light 18 is transmitted into the LGP 12 and propagates therein. Some displaying light in the LGP 12 directly emits therefrom via the backlight transmissive region 14 of the light outputting surface of the LGP 12, whereby the some displaying light can be fully utilized after it leaves the backlight transmissive region 14. Some displaying light is reflected by the second reflective layer 13 at a bottom surface of the LGP 12 and then emits from the LGP 12 via the backlight transmissive region 14 of the light outputting surface of the LGP 12, whereby the some displaying light can also be fully utilized after it leaves the backlight transmissive region 14. Some displaying light is reflected by the second reflective layer 13 at the bottom surface of the LGP 12 and directed thereby to the backlight reflective regions 15 of the light outputting surface of the LGP 12 or is directly guided to the backlight reflective regions 15. For such some displaying light, in accordance with the prior art, it is shielded from moving anymore and cannot be used, whereby such some displaying light is wasted and the utilization efficiency of the displaying light is reduced. In accordance with the present disclosure, by the first reflective layer 11 provided on the backlight reflective regions 15 of the light outputting surface of the LGP 12, the originally shielded displaying light is reflected by the first reflective layer 11 and is reflected in the LGP 12 to continue its movement until the originally shielded displaying light emits from the LGP 12 via the backlight transmissive region 14 of the LGP 12, whereby such some displaying light still can be fully utilized. The wasted displaying light in accordance with the prior art gets its use in accordance with the present disclosure, thereby to improve light utilization and light efficiency and reduce power consumption of the LCD.

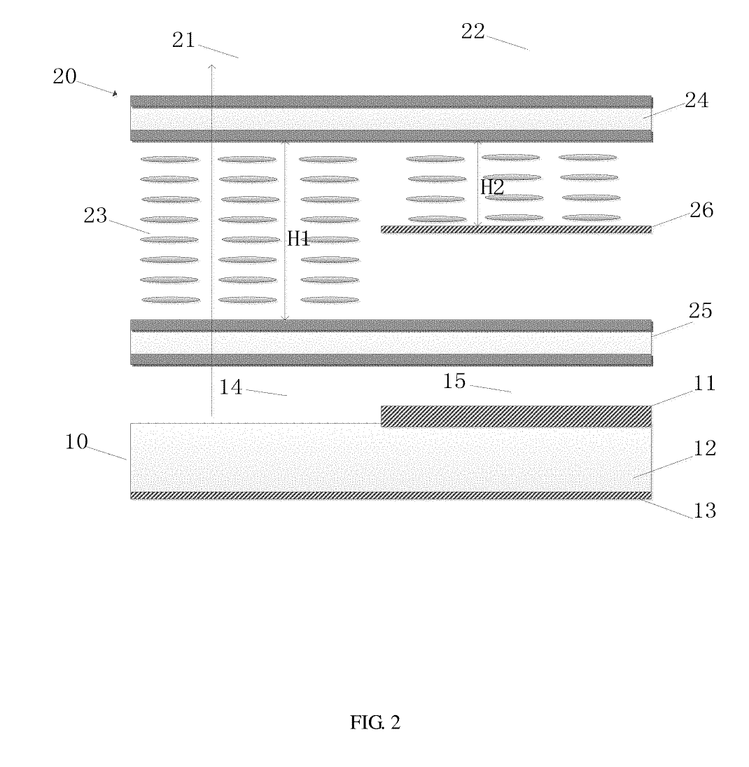

As shown in FIG. 2, the embodiment provides a transflective LCD comprising a LCD panel 20 and the backlight unit 10. The backlight unit is described in above specification, and it will be further described in detail (the lampshade and the light bar are shown in the backlight unit of FIG. 1).

The LCD panel 20 comprises a transmissive region 21 of the LCD panel and a reflective region 22 of the LCD panel. The transmissive region 21 of the LCD panel comprises a top substrate, a liquid crystal layer, and a bottom substrate. The reflective region 22 of the LCD panel comprises a top substrate 24, a liquid crystal layer 23, a bottom substrate 25 and a reflective layer 26 of the LCD panel arranged between the top substrate 24 and the bottom substrate 25.

The backlight reflective regions 15 correspond to the reflective region 22 of the LCD panel, and the backlight transmissive regions 14 correspond to the transmissive regions 21 of the LCD panel. Thus, the displaying light shielded by the reflective layer of the LCD panel is reflected in the LGP 12 via the first reflective layer 11 to continue to transmit until the shielded displaying light emits from the backlight transmissive regions 14 and enters the transmissive regions 21 of the LCD panel, which avoids the display light from wasting. The displaying light is fully utilized, which improves light utilization and light efficiency and reduces power consumption of a liquid crystal display (LCD).

Height H1 of the liquid crystal layer of the transmissive regions 21 of the LCD panel is greater than height H2 of the liquid crystal layer of the reflective regions 22 of the LCD panel, and the preferred height difference is: H1=2H2, which allows that the transmissive regions 21 of the LCD panel and the reflective regions 22 of the LCD panel have same electro-optical characteristic, further improving light utilization and light efficiency of the transflective LCD, and image displaying. The liquid crystal layer of the transmissive regions 21 of the LCD panel and the liquid crystal layer of the reflective regions 22 of the LCD panel can use same liquid crystal material.

In the present disclosure, the first reflective layer 11 is micro-structure. The transflective LCD makes each sub-pixel divided into sub-regions of the transmissive regions of the LCD panel and sub-regions of the reflective regions of the LCD panel. For example, in a 300 PPI display of a phone there are 300 sub-pixels per inch, and accordingly there are 300 sub-regions of the reflective regions of the LCD panel per inch. The number and position of the first reflective layer 11 are strictly correspondent to the number and position of the sub-regions of the reflective regions of the LCD panel.

Combined FIG. 2 and FIG. 1, the movement of the displaying light in the display panel 20 is similar to the movement of the displaying light in the backlight unit as disclosed above. The displaying light that emits from the backlight transmissive regions, is directed to the transmissive region of the LCD panel and is fully utilized, which improves light utilization and light efficiency, and reduces power consumption of the LCD.

As the above, it should be understood that the present disclosure has been described with reference to certain preferred and alternative embodiments which are intended to be exemplary only and do not limit the full scope of the present disclosure as set fourth in the appended claims.

What is claimed is:

1. A backlight unit for a transflective liquid crystal display (LCD) panel, comprising:
a light bar generating displaying light;
a light guide plate (LGP) transmitting the displaying light to the display panel, and having a light outputting surface, which comprises a backlight transmissive regions and backlight reflective regions; and
a first reflective layer provided on the backlight reflective region of the LGP to reflect the displaying light corresponding to the backlight reflective region.

2. The backlight unit for the transflective display panel as claimed in claim 1, further comprising a second reflective layer is arranged on a bottom surface of the LGP, wherein material of the first reflective layer comprises metal, and material of the second reflective layer comprises metal.

3. The backlight unit for the transflective display panel as claimed in claim 1, wherein the backlight transmissive regions and the backlight reflective regions are alternately arranged on the light outputting surface of the LGP.

4. The GOA circuit as claimed in claim 1, wherein the first reflective layer is a single-sided reflective layer and has a reflective surface facing the LGP.

5. A transflective liquid crystal display (LCD), comprising
an LCD panel; and
a backlight unit;
wherein the LCD panel comprises transmissive regions of the LCD panel and reflective regions of the LCD panel;
wherein the transmissive regions of the LCD panel comprise a top substrate, a liquid crystal layer, and a bottom substrate;
wherein the reflective regions of the LCD panel comprise a top substrate, a liquid crystal layer, a bottom substrate, and a reflective layer of the LCD panel arranged between the top substrate and the bottom substrate;
wherein the backlight unit comprises:
a light bar generating displaying light;
a light guide plate (LGP) transmitting the displaying light to the display panel, having a light outputting surface, which comprises backlight transmissive regions and backlight reflective regions; and
a first reflective layer provided on the backlight reflective regions of the LGP to reflect the displaying light corresponding to the backlight reflective region.

6. The transflective LCD as claimed in claim 5, wherein the backlight reflective regions correspond to the reflective regions of the LCD panel, and the backlight transmissive regions correspond to the transmissive regions of the LCD panel.

7. The transflective LCD as claimed in claim 5, wherein height of the liquid crystal layer of the transmissive regions of the LCD panel is greater than height of the liquid crystal layer of the reflective regions of the LCD panel.

8. The transflective LCD as claimed in claim 5, wherein a second reflective layer is arranged on a bottom surface of the LGP, material of the first reflective layer comprises metal, and material of the second reflective layer comprises metal.

9. The transflective LCD as claimed in claim 5, wherein the first reflective layer is a single-sided reflective layer and has a reflective surface facing the LGP.

10. The transflective LCD as claimed in claim 5, wherein the backlight reflective regions and the backlight transmissive regions are alternately arranged on the light outputting surface of the LGP.
